(19) United States
(12) Patent Application Publication
(10) Pub. No.: US 2011/0220498 A1
(43) Pub. Date: Sep. 15, 2011

(54) Method for Building Massively-Parallel Preconcentration Device for Multiplexed, High-Throughput Applications

(75) Inventors: Sung Hee Ko, Gyungbuk (KR); Sung Jae Kim, Melrose, MA (US); Jongyoon Han, Bedford, MA (US)

(73) Assignee: Massachusetts Institute of Technology, Cambridge, MA (US)

(21) Appl. No.: 12/958,465

(22) Filed: Dec. 2, 2010

Related U.S. Application Data
(60) Provisional application No. 61/313,445, filed on Mar. 12, 2010.

(51) Int. Cl. G01N 27/447; F15C 1/06

(52) U.S. Cl. 204/451; 204/601; 137/833

(57) ABSTRACT

A multiplexed concentration interface that can connect with a plurality of microchannels, conventional 96 well plates or other microarrays is disclosed. The interface can be used in biosensing platforms and can be designed to detect single or multiple targets such as DNA/RNA, proteins and carbohydrates/oligosaccharides. The multiplexed concentration device will provide a set of volume-matched sample preparation and detection strategies directly applicable by ordinary researchers. Furthermore, a multiplexed microfluidic concentrator without buffer channels is disclosed.

### RELATED PARAGRAPH

This application claims the benefit of U.S. Provisional Application No. 61/313,445, filed on Mar. 12, 2010. The entire teaching of the above application is incorporated herein by reference.

### GOVERNMENT SUPPORT

The invention was supported, in whole or in part, by Grant No. CBET-0854026; 6919872 from the National Science Foundation and by Grant No. EB005743; 6898600 from National Institute of Health. The Government has certain rights in the invention.

### FIELD OF THE INVENTION

This invention relates to microfluidic chips and microfluidic concentrators for charged ions including biopolymers.

### BACKGROUND OF THE INVENTION

Sample preparation continues to be one of the bottlenecks in various forms of bioanalysis, regardless of target molecules, detection methods, and the sources of raw samples. During the past decades, significant progress has been made both in binding assays (immunoassays) and mass spectrometry (MS), realizing greatly improved sensitivity and specificity. However, issues related to sample background and low abundance target create challenges in fully utilizing the power of these new analysis platforms. Interference from background molecules is often cited as the factor to limit the reliability of immunoassay directly from serum or body fluids. (Travis, J. and P. Pannell, Selective removal of albumin from plasma by affinity chromatography. Clinica Chimica Acta, 1973. 49, 49-52; De Jager, W., et al., Improved multiplex immunoassay performance in human plasma and synovial fluid following removal of interfering heterophilic antibodies. Journal of Immunological Methods, 2005. 300 (1-2), 124-135; Govorukhina, et al., Sample preparation of human serum for the analysis of tumor markers: Comparison of different approaches for albumin and [gamma]-globulin depletion. Journal of Chromatography A, (2003), 1009 (1-2):171-178) The number of protein species in a cell or tissue sample is believed to be in the several hundreds of thousands, spanning a concentration range of seven or more orders of magnitude. There is no single analytical method available today that is capable of resolving and detecting such a diverse sample. (Hamdan, M. and P. G. Righetti, Modern strategies for protein quantification in proteome analysis: Advantages and limitations. Mass Spectrometry Reviews, 2002. 21, 287-302; Hamdan, M. and P. G. Righetti, Assessment of protein expression by means of 2-D gel electrophoresis with and without mass spectrometry. Mass Spectrometry Reviews, 2003; 272-284; Ferguson, P. L. and R. D. Smith, Proteome Analysis by Mass Spectrometry. Annual Review of Biophysics and Biomolecular Structure, 2003. 32, 399-424). Most detection/separation technologies (immunoassays, 2D gel electrophoresis, etc.) have limited dynamic range of less than 10⁴, which is not ideal for comprehensive proteome mapping. The study of low-abundance proteins such as cellular receptors and transcription factors in crude cell protein extracts is therefore compromised by its limited dynamic range and limited sample capacity (1-2 mg). In general, only the high-abundance proteins are detected while the low-abundance remained undetected, and it is largely expected that this critical challenge will be resolved by developing advanced protein/ion preconcentration techniques. (Anderson, N. L. and N. G. Anderson, The human plasma proteome: history, character, and diagnostic prospects. Mol. Cell. Proteomics, 2002, 845-867; Rabilloud, T., Two-dimensional gel electrophoresis in proteomics: Old, old fashioned, but it still climbs up the mountains. Proteomics, 2002, 3-10; Righetti, P. G., et al., Prefractionation techniques in proteome analysis. Proteomics, 2003).

Previously, we reported nanofluidic devices that can achieve efficient, continuous biomolecule trapping/concentration. (Wang, Y.-C., A. L. Stevens, and J. Han, Million-fold Preconcentration of Proteins and Peptides by Nanofluidic Filter. Analytical Chemistry, (2005) 77 (14); 4293-4299; U.S. Patent Applications 20070090026, 20040035701, 20090047681, 20090120796). These devices utilize the fact that nanochannels as thin as 40 nm can function as perm-selective membranes, even at moderate buffer concentrations (10 mM or higher). It is well established that such a perm-selective ion current can generate ion concentration polarization, which is a phenomenon in which ionic species (both positively and negatively charged) are depleted from the membrane (in this case, the nanochannel) that supports the perm-selective ion current. As a result, biomolecules and ions, and any charged biomolecules, are ‘repelled’ away from the region rather strongly, forming a so-called ‘ion depletion region’ (Pu, H. T. and Q. Z. Liu, Methanol permeability and proton conductivity of polybenzimidazole and sulfonated polybenzimidazole, Polymer International, 2004, 53 (10):1512-1516). Utilizing this force, in conjunction with counteracting flow (either electroosmotic flow or pressure-driven flow), forms a field-addressable, continuously-operation molecular concentration system. This device demonstrates high concentration factors (up to ˜10⁶), does not require special buffer arrangements (unlike in sample stacking/isotachophoresis), and is generally applicable to charged molecules, small or large (unlike membrane filtration based concentration scheme, which is sensitive to the size cutoff). (Jung, B., R. Bharadwaj, and J. G. Santiago, On-chip Millionfold Sample Stacking Using Transient Isotachophoresis. Analytical Chemistry, (2006) 78 (7):2319-2327; Hatch, A. V., et al., Integrated preconcentration SDS-PAGE of proteins in microchips using photo patterned cross-linked polyacrylamide gels Analytical Chemistry, (2006) 78 (14):4976-4984).

While the previous microfluidic concentrators allow for good concentration factors, the actual volume of the concentrated plug is too small to be coupled with other sensors. The simplest way to overcome the problem is increasing microchannel dimension, but the depth of the microchannel (where the depletion zone is formed) has an impact on the efficiency of depletion process and concentration speed. Keeping the same nanochannel, but increasing the depth/size of the microchannel leads to poor depletion and slow preconcentration.

Increasing the nanochannel ion conductance leads to more stable and efficient concentration, even in larger microchannels. This can be achieved either by (1) building vertical nanochannel membrane instead of planar nanochannel, or (2) one of the many non-lithographic nanojunction fabrication methods (utilizing nanoporous polymeric material such as Nafion). (Lee, J. H., et al., Poly(dimethylsiloxane)-Based Protein Preconcentration Using a Nanogap Generated by Junction Gap Breakdown. Analytical Chemistry, 2007, 79, 6868-6873; Lee, J. H., Y.-A. Song, and J. Han, Multiplexed Proteomic Sample Preconcentration Device Using Surface-Patterned Ion-Selective Membrane Lab on a Chip, 2008, 8:596-601.; Kim, S. J. and J. Han, Self-Sealed Vertical Polymeric Nanoporous Junctions for High Throughput Nanofluidic Applications. Analytical Chemistry, 2008, 80:3507-3511; Chung, S., et al., Non-lithographic wrinkle nanochannels for protein preconcentration. Advanced Materials, 2008, 20:3011-3016). These non-lithographic techniques are amenable to PDMS microfluidics and can be implemented with only basic fabrication steps, allowing much more widespread use of the device. Also, turn-around of the device is much faster, making it a useful prototyping method. These PDMS-concentration devices are more advantageous because they are easier and economical to fabricate, while at the same time providing good concentration efficiency and sample plug volume.

Automating raw biosample processing steps is still challenging due to several important technical issues. Typically the sample volume to be analyzed varies significantly (from mL to pL), depending on specific applications. There is also a need to analyze multiple targets simultaneously while minimizing interference from their molecular background. At the same time, a sample preparation system should be properly interfaced to the sensors with a manner that meets the specific requirements of each sensing system. Developing proper sample preparation process requires careful considerations and appropriate tools and processes seamlessly integrated.

Conventional nanofluidic concentrator includes a main microchannel and a buffer microchannel that are connected to each other with a nanochannel of nanoporous junction. (FIG. 1(a)). In such a device, at least two electrical connections are required for obtaining proper concentration polarization (or concentrated plug). Such architecture leads to 2n electrical connection where n is the number of desired degree of multiplexing. For example, the radial-multiplexed concentrator reported by Lee et al., is capable of concentrating 10 plugs at once with 22 electrical connections. (Lee, J. H., Y.-A. Song, and J. Han, Multiplexed Proteomic Sample Preconcentration Device Using Surface-Patterned Ion-Selective Membrane Lab on a Chip, 2008. 8: p. 596-601). The large number of electrical connection limits the applicability to the practical system and the design flexibility. Moreover, one needs to put four electrical connections per one concentrated plug for desirable concentration stability. Thus, the conventional operation is not suitable for being adapted to multiplexed concentration devices. As such, there exists a need to concentrate biological sample in a massive multiplexed way, while maintaining electrical connections as few as possible and improving design flexibility.

In fluidic concentrators, the necessity of a buffer channel connection raises a design limitation or flexibility. The buffer channel acts as a drain of ions that was passing through the perm-selective junction. Thus, it would be a great improvement in terms of device simplicity, if one can implement the drain role by using metal substrate instead of liquid drain channel because one can sputter the thin microelectrode anywhere on the device.

### SUMMARY OF THE INVENTION

This invention relates to microfluidic concentrators in which a first single channel is connected to another set of two or more microchannels so as to reduce the need for connecting each microchannel to individual electrodes. A multiplexed concentration interface that can connect with a plurality of microchannels, conventional 96 well plates or other microarrays is disclosed. The interface can be used in biosensing platforms and can be designed to detect single or multiple targets such as DNA/RNA, proteins and carbohydrates/oligosaccharides. The multiplexed concentration device will provide a set of volume-matched sample preparation and detection strategies directly applicable by ordinary researchers. Furthermore, a multiplexed microfluidic concentrator without buffer channels is disclosed.

The invention further relates to a method of controlling the speed and efficiency of concentrating a sample by controlling the tangential electric field. The invention further relates to adjusting electrical field in a concentration device by changing the length of the microchannels.

### BRIEF DESCRIPTION OF THE DRAWINGS

FIG. 1: Schematic diagram of conventional nanofluidic preconcentration device.

FIG. 2: (a) Schematic diagram of multiplexed concentration device; (b) showing diagram of a fabricated device of the same or similar length channels to give similar concentration factors between channels; (c) and (d) shows diagrams of fabricated device with varying microchannel lengths with 8 and 16 channels respectively.

FIG. 3: (a) The operation demonstration of the same length concentration devices and fluorescent intensity plot for showing the same concentration factor. (b) The operation demonstration of the different length concentration devices and fluorescent intensity plot for showing the gradation of concentration factor. (c) Anti-CRP functionalized bead-based binding assay result using 16 channel multiplexed concentrator device. (d) Fluorescent image of 128 channel multiplexed concentration device. The photo was rotated at 90 degree.

FIG. 4: (a) Schematic diagram of new concentration device using solid buffer channel system and (b) its operation demonstration. (c) Schematic diagram of extension for high-throughput multiplexed radial concentration device.

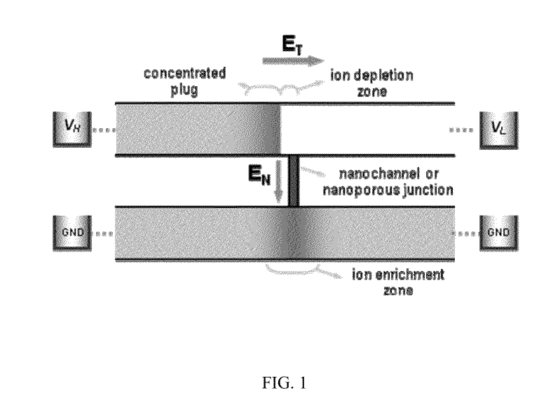

### DETAILED DESCRIPTION OF THE INVENTION

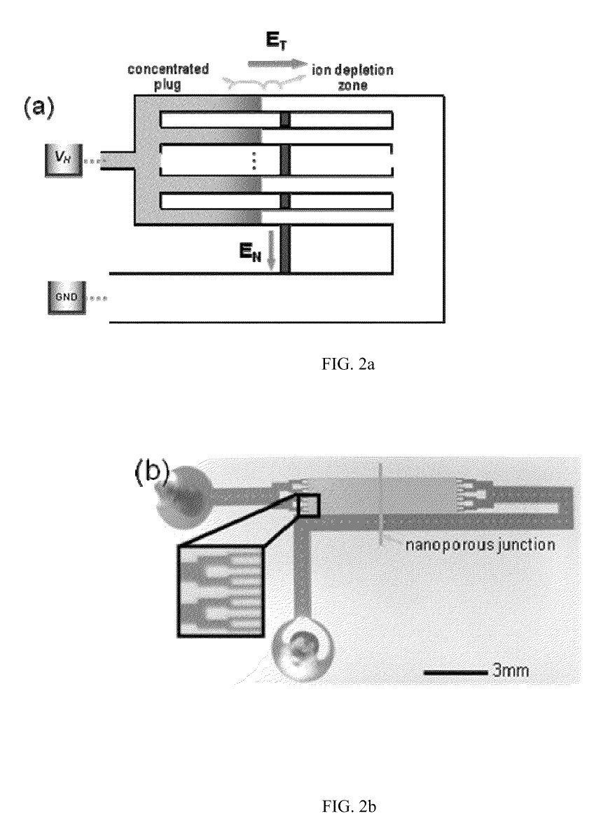

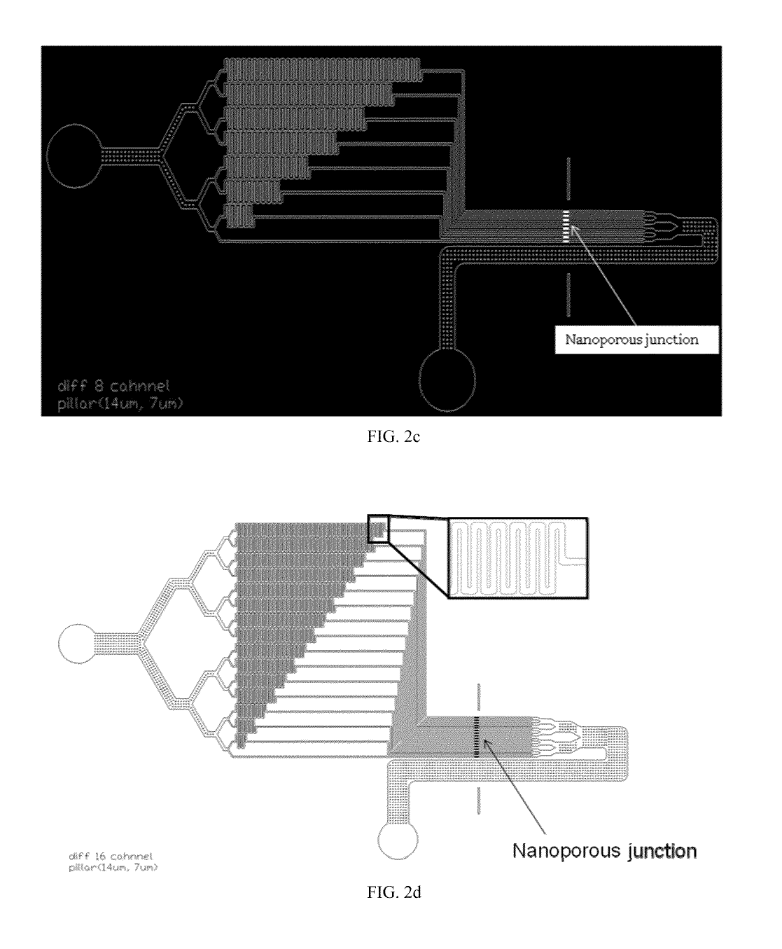

In part the invention provides a microfluidic concentrator that has a limited/reduced ion enrichment zone. In one embodiment, the microfluidic concentrator has an electrode connected microchannel, which is further divided into a plurality of microchannels. In an embodiment, the main channel is connected to a buffer channel (FIG. 2(a)). In one embodiment the device has tangential electric field (E_{T}) and normal electric field (E_{N}) that are similar to conventional devices, however, with a reduced ion enrichment zone. Without being bound to any particular theory, it is believed that the reduction in ion enrichment zone is due to strong amplified electrokinetic flow that pushes the enriched ions toward the reservoir at ground electrode. In one embodiment, the device is extended to a multiplexed system. In one embodiment, the multiplexed system has fewer electrical connections than conventional systems.

In one embodiment, the concentrating speed depends on the flow rate through h sample microchannels, rather than E_{N} which can be related to the vertical distance between sample channel and buffer channel. Without being bound by any theory, it is postulated that the flow rate of electrokinetic flow largely depends on E_{T}, and less on the cross-sectional area of the microchannel. Thus, the flow rate can be controlled by adjusting the length of sample microchannels, as shown in FIG. 2(c) (8-channel successive preconcentration device), and FIG. 2(d) (16-channel successive preconcentration device). In some embodiments, the device contains at least two sample microchannels with different lengths wherein at least one sample microchannel is at least about 25%, 50%, 75%, 100%, 150%, 200%, 300%, 400%, 500%, 600%, 700%, 800%, 900%, 1,000%, 2,000%, 3,000%, 4,000%, 5,000%, 6,000%, 7,000%, 8,000%, 9,000%, 10,000%, 20,000%, 40,000%, 60,000%, 80,000%, 100,000% or 1,00,000% longer than the shortest sample microchannel. In some embodiments, the device contain between, 2 and 600,000 sample microchannels, preferably between 2 and 66,000 sample microchannels, preferably between 2 and 33,000 sample microchannels, preferably between 2 and 17,000 sample microchannel, preferably between 2 and 8200 sample microchannels, preferably between 2 and 4100 sample microchannels, preferably between 2050 sample microchannels, preferably between 2 and 1024 sample microchannels, preferably between 2 and 512 sample microchannels, preferably between 2 and 256 sample microchannels, preferably between 2 and 128 sample microchannels, preferably between 2 and 64 sample microchannels, preferably between 2 and 32 sample microchannels, preferably between 2 and 16 sample microchannels, preferably between 2 and 8 sample microchannels, wherein at least one sample microchannel is at least about 10%, 25%, 50%, 75%, 100%, 150%, 200%, 300%, 400%, 500%, 600%, 700%, 800%, 900%, 1,000%, 2,000%, 3,000%, 4,000%, 5,000%, 6,000%, 7,000%, 8,000%, 9,000%, 10,000%, 20,000%, 40,000%, 60,000%, 80,000%, 100,000% or 1,00,000% longer than the shortest sample microchannel. In some embodiments, there are multiple sample microchannels that are similar or same in length as the shortest sample microchannel while containing one or more longer sample microchannels. In some embodiments, there are more than two sample microchannels having varying lengths. In a preferred embodiment, the device contain about 4, 8, 16, 32, 64, 128 or 256 sample microchannels wherein at least 1-255 sample microchannels are at least about 10%, 25%, 50%, 75%, 100%, 150%, 200%, 300%, 400%, 500%, 600%, 700%, 800%, 900%, 1,000%, 2,000%, 3,000%, 4,000%, 5,000%, 6,000%, 7,000%, 8,000%, 9,000%, 10,000%, 20,000%, 40,000%, 60,000%, 80,000%, 100,000% or 1,00,000% longer than the shortest sample microchannel. In some embodiments, the sample microchannels are fabricated in a curved shape, while in some embodiments, all sample microchannels are substantially linear. In some embodiments, some of the sample microchannels are substantially linear while some of the sample microchannels are curved. In some embodiments, the curved sample microchannels are s-shaped. In one embodiment, the shortest sample microchannel is about 20-100,000 μm, preferably between 100 and 10000 μm, preferably between 500 and 5,000 μm in length. In one embodiment, the device contain a sample microchannel having about 20-100,000 μm, preferably between 100 and 10000 μm, preferably between 500 and 5,000 μm, and at least another sample microchannel that has a length that is a multiple of at least about 2, 3, 4, 5, 6, 7, 8, 9, 10, 11, 12, 15, 20, 30, 40, 50 or 100. In one embodiment, a device may contain a plurality of high aspect ratio, ion selective membranes. In one embodiment a plurality of high-aspect ratio ion selective membranes can be fabricated on a chip. In one embodiment fabrication of a plurality of high-aspect ratio ion selective membranes may be accomplished using multi-blade fabrication. In one embodiment multi-blade fabrication can be used for commercialization of a device containing a self-sealed membrane. In one embodiment a self-sealed membrane refers to the high aspect ratio ion selective membrane. In one embodiment “self-sealed” means that after infiltration, or passage or filling of the trench or the gap, or the scratch made by the blade with a liquid polymer solution, unbending the chip and solidifying the polymer causes a self-sealing process of the scratch or the gap or the trench by the polymer.

Ion-selective or ion-exchange membrane refers to membranes that allow the passage of the ions, while substantially maintaining the integrity between the coantents separated by the membrane. The particular material selected for membrane can be changed for the electrode materials selected and the desired rate of exchange of ions. Examples of ion-selective membranes include high aspect ratio ion-selective membranes made from polytetrafluroethylenes, perfluorosulfonates, polyphosphazenes, polybenzimidazoles, poly-zirconia, polyethyleneimine-poly(acrylic acid), poly(ethylene oxide)-poly(acrylic acid) and non-fluorinated hydrocarbon polymers. A preferred membrane is selected from Nafion, CMI 7000, Membranes International C/R, CMB and CCG-F from Ameridia, AM-1, AM-3 and AM-X and PC-200D.

In one embodiment, multi-blade fabrication can be used for massive parallelization of the membrane or the device fabrication process. In one embodiment, multi-blade fabrication can be used to make a plurality of membranes in parallel. In one embodiment, multi-blade fabrication renders the fabrication process fast. In one embodiment, multi-blade fabrication renders the device a low-cost device. In one embodiment multi-blade fabrication is combined with multi-syringe or multi dispenser system that enables parallel injection of liquid polymer to all trenches or cuts made by the multiple blades. In one embodiment the multi-blade fabrication technique is part of an automated fabrication technique, in which all steps of forming the high aspect ratio ion selective membranes are automated, and all steps are performed in parallel on many channels or on many device parts or on many devices. In one embodiment such automation enables mass production of devices, low cost, high yield and reproducibility of device properties. In one embodiment parallel multi-blade fabrication facilitates quality control and reliability measurements to be done on selected devices. In one embodiment multi-blade fabrication and/or automation of the process are achieved using computers, computer programs, robotics or a combination thereof. In one embodiment the number of high aspect ratio ion selective membranes produced is equal to the number of channels described herein above. In one embodiment the number of high aspect ratio ion selective membranes produced is greater than the number of channels described herein above. In one embodiment the number of high aspect ratio ion selective membranes produced is smaller than the number of channels described herein above. In one embodiment the number of high aspect ratio ion selective membranes produced is more than 5, or, in other embodiments, more than 10, 96, 100, 384, 1,000, 1,536, 10,000, 100,000 or 1,000,000 channels, or in any number desired to suit a particular purpose.

In one embodiment, the width of the microchannel is between about 0.1-500 μm, and in one embodiment, the width of the channel is between about 5-200 μm. In one embodiment, the width of the channel is between about 20-1200 μm. In one embodiment, the width of the channel is between about 50 and 500 μm. In one embodiment, the width of the channel is between about 50 and 250 μm.

In one embodiment, the depth of the microchannel is between about 0.5-200 μm, and in one embodiment, the depth of the channel is between about 5-150 μm. In one embodiment, the depth of the channel is between about 5-100 μm. In one embodiment, the depth of the channel is between about 5-50 μm. In one embodiment, the depth of the channel is between about 5-25 μm. In one embodiment, the depth of the channel is between about 10-25 μm. In one embodiment, the depth of the channel is between about 10-20 μm.

In one embodiment, the ion-selective membrane has a width of between about 0.01-100 μm. In one embodiment, the width of the ion-selective membrane is between about 1-10 μm. In one embodiment, the ion-selective membrane has a width of between about 100-500 μm. In one embodiment, the ion-selective membrane has a depth of between about 0.01-3000 μm. In one embodiment, the depth of the ion-selective membrane is between about 10-500 μm. In one embodiment, the depth of the ion-selective membrane is between about 100-1000 μm. In one embodiment, the ion-selective membrane has a depth of between about 500-1100 μm. In one embodiment, the membrane is cation selective. In one embodiment, the membrane is anion selective.

In one embodiment, the fluidic chip comprises a silicon polymer, preferably, polydimethylsiloxane. In one embodiment, the fluidic chip has a hydrophobic surface. In one embodiment, the fluidic chip comprises an elastomeric polymer. The elastomeric polymer can be a silicone elastomeric polymer. The elastomeric polymer can be solidified by curing. In one embodiment, the elastomeric polymer can be treated with high intensity oxygen or air plasma to permit bonding to the compatible polymeric or non-polymeric media. The polymeric and non-polymeric media can be glass, silicon, silicon oxide, quartz, silicon nitride, polyethylene, polystyrene, glassy carbon, or epoxy polymers.

Construction of the microchannels may be accomplished according to, or based upon any method known in the art, for example, as described in Z. N. Yu, P. Deshpande, W. Wu, J. Wang and S. Y. Chou, Appl. Phys. Lett. 77 (7), 927 (2000); S. Y. Chou, P. R. Krauss, and P. J. Renstrom, Appl. Phys. Lett. 67 (21), 3114 (1995); Stephen Y. Chou, Peter R. Krauss and Preston J. Renstrom, Science 272, 85 (1996), U.S. Patent Publication 20090242406, and U.S. Pat. No. 5,772,905. In one embodiment, the microchannels can be formed by imprint lithography, interference lithography, self-assembled copolymer pattern transfer, spin coating, electron beam lithography, focused ion beam milling, photolithography, reactive ion-etching, wet-etching, plasma-enhanced chemical vapor deposition, electron beam evaporation, sputter deposition, stamping, molding scanning probe techniques and combinations thereof. In some embodiments, the methods for preparation of the devices of this invention may comprise or be modifications of Astorga-Wells J. et al, Analytical Chemistry 75: 5207-5212 (2003); or Joensson, M. et al, Proceedings of the MicroTAS 2006 Symposium, Tokyo Japan, Vol. 1, pp. 606-608. Alternatively, other conventional methods can be used to form the microchannels. In one embodiment, the microchannels are formed as described in J. Han, H. G. Craighead, J. Vac. Sci. Technol., A 17, 2142-2147 (1999) and J. Han, H. G. Craighead, Science 288, 1026-1029 (2000).

In one embodiment, a series of reactive ion etchings are conducted, after which nano- or micro-channels are patterned with standard lithography tools. In one embodiment, the etchings are conducted with a particular geometry, which, in another embodiment, determines the interface between the microchannels, and/or nanochannels. In one embodiment, etchings, which create the microchannels, are performed parallel to the plane in which etchings for the nanochannels are created. In another embodiment, additional etching, such as, for example, and in one embodiment, KOH etching is used, to produce additional structures in the device, such as, for example, for creating loading holes.

In one embodiment, an interface region is constructed which connects the channels on the chip, for example two microchannels. In one embodiment, diffraction gradient lithography (DGL) is used to form a gradient interface between the channels of this invention, where desired. In one embodiment, the gradient interface region may regulate flow through the concentrator, or in another embodiment, regulate the space charge layer formed in the microchannel, which, in another embodiment, may be reflected in the strength of electric field, or in another embodiment, the voltage needed to generate the space charge layer in the microchannel. In some embodiments, the ion-selective membrane is positioned at such an interface.

In another embodiment, the device may contain at least two pairs of electrodes, each providing an electric field in different directions. In one embodiment, field contacts can be used to independently modulate the direction and amplitudes of the electric fields to, in one embodiment, orient the space charge layer, or a combination thereof.

If not otherwise specifically set forth, the term “less than” refers to a quantity that has a lower limit of zero. If the lower limit of zero is not practical, the term refers to the lowest practical limit for that specific parameter. In part, the invention provides a multiplexed microfluidic device comprising, a rigid substrate containing a first microchannel connected to a first electrode, wherein said first microchannel is further connected to a second set of two or more microchannels. The multiplexed microfluidic device may further comprise a third microchannel connected to a second electrode wherein said second microchannel is connected to said second set of microchannels. In one embodiment, the first electrode and second electrode provide electric fields in different directions. In some embodiments the third microchannel serves as a buffer channel.

Referring now to the drawings and in particular to FIG. 2(a), there is shown schematically a fluidic microchip device in accordance with the present invention. Fluidic microchip device is designed and fabricated from PDMS. Other materials, including polymers, quartz, fused silica, sapphire, or plastics are also suitable as substrate materials. The fluidic chip has a sample channel to which an electrode may be connected. The sample channel is connected to a first channel which in turn is connected to a second set of channels. The second set of channels are a set of channels which includes two or more channels that are connected to the first channel and channels that are created by splitting/dividing any of those channels. For example, FIG. 2(b) shows a first channel which is split into two channels which are further split into four channels, which in turn are split to 8 and further to 16 channels, creating a multiplex of channels. The second set of channels includes all those channels which are formed from splitting or dividing or otherwise connected to the first channel. The second set of channels further contains a nanoporous junction. In one embodiment, the nanoporous junction forms a porous barrier to at least some of the channels is the second set of channels. While on one side of the nanoporous junction sample is input, the other side of the nanojunction may contain a buffer channel. The buffer channel acts as a drain for ions passing through the nanoporous junction. On the buffer channel side of the nanoporous junction, the second set of channels may be merged into a second set of merged channels. The merged channels may be connected to the buffer channel.

In regards to depth and width, the split channels created from a primary channel may be of the same size as the primary channel, larger in size or smaller in size. In a preferred embodiment, the split channels are smaller in size than the primary channels from which they are split. For example, in a preferred embodiment, the size of any one of the second set of channels is smaller than the first channel with respect to width and/or depth. In a preferred embodiment the merged channels are wider and/or deeper in size than any of the second set of channels. In one embodiment, the buffer channel is microfluidic channel through which a stream of sample may pass through.

In one embodiment, the microfluidic microchannel is absent, and a solid metal substrate instead of a liquid drain channel acts to drain ions passing through a nanoporous junction.

In part the invention provides, a microfluidic device comprising: a solid substrate; a single microfluidic channel or an array of microfluidic channels or a set of two or more microfluidic channels; a nanoporous junction intersecting a portion of said microfluidic channels; and a solid substrate positioned so as to capture at least a portion of ions passing through said nanoporous junction.

The solid substrate may be any solid material that can capture ions of interest passing through a nanoporous junction. For example, Nafion junction allows for cations, and a solid substrate that can capture cations is appropriate in such a microdevice. On the other hand a junction that allows anions to pass through can use a substrate that absorbs or captures anions. In some embodiments substrates is selected from aluminum, copper, silver, gold, titanium, platinum, or tungsten. In some embodiments, an adhesion layer is used to adhere the solid/metal substrate to a rigid substrate containing microchannels/microdevice, preferably a glass rigid substrate. In a preferred embodiment, the adhesion layer is made from titanium or a titanium alloy. The adhesive layer may have a width of between about 0.5 μm to about 2000 μm, or between about 10 μm to about 1000 μm, or between about 50 μm to about 500 μm, or between about 75 μm to about 2300 μm. In one embodiment, the adhesion layer has a height of between about 10-10,000 nm, or between about 15-1,000 nm, or between about 25-500 nm, or between about 50-250 nm or between about 50-200 nm. In one embodiment, the substrate for absorbing ions is a metal substrate, for example gold. In one embodiment, a gold substrate is adhered to a glass rigid substrate using a titanium layer as adhesive. In a preferred embodiment, the gold layer has between about 0.1-10,000 nm, or between about 10-5,000 nm, or between about 50-1000 nm or between about 75-250 nm. In a preferred embodiment the solid substrate for capturing ions is a gold microelectrode. In a preferred embodiment, the microelectrode is placed in the middle (or within a part) of a 96-well plate.

In a preferred embodiment, a fabricated microfluidic chip contains: a first set of microchannels; a nanoporous junction intersecting at least a portion of said microchannels; a solid buffer positioned so as to capture ions passing through said nanoporous junction. A sample liquid containing a species of interest can be placed on one side of the nanoporous junction, referred to as “plug side” or “sample side.” The ions that pass through the junction enters the other side, referred to as, “ion depletion zone.” In a preferred embodiment, first electrode or a set of electrodes is attached to microchannels on the plug side of the junction and a second electrode or metal substrate is placed on the ion depletion zone to capture ions passing through the junction. In a preferred embodiment, the first electrode defines the surface boundaries of an area within which both nanoporous junction and the second electrode metal substrate are placed.

### EXAMPLES

A 16-channel multiplexed polydimethylsiloxane (PDMS) chips with perm-selective nanojunctions was fabricated using surface patterned nanojunction method (Lee, J. H., Y.-A. Song, and J. Han, Multiplexed Proteomic Sample Preconcentration Device Using Surface-Patterned Ion-Selective Membrane Lab on a Chip, 2008. 8: p. 596-601), as shown in FIG. 2(b). In order to match the hydraulic flow resistance, the device has proper splitting/merging scheme with the buffer channel whose size is the same as the total summation of individual sample microchannel. Each sample microchannels has the dimension of 50 μm width×15 μm depth. The concentrating speed correlated with the flow rate through each sample microchannel, and less with E_{N} which can be determined by the vertical distance between each sample channel and buffer channel. Since the flow rate of electrokinetic flow correlates with E_{T}, and less on the cross-sectional area of microchannel, it can be controlled by adjusting total length of each sample microchannel as shown in FIG. 2(d) (16-channel successive preconcentration device). The operation of these devices were carried using 1 mM of potassium phosphate dibasic solution (pH=8.4) as main buffer solution and 1 μng/ml of FITC for fluorescent tracking. All the electrokinetic behaviors were imaged with an inverted fluorescence microscope (Olympus, IX-51) and a CCD camera (SensiCam, Cooke corp.). Sequences of images were analyzed by Image Pro Plus 5.0 (Media Cybernetics inc.). A dc power supply (Keithley 6514) was used to apply electrical potential to each reservoir and the connection was done by Ag/AgCI electrodes (A-M Systems, Inc.).

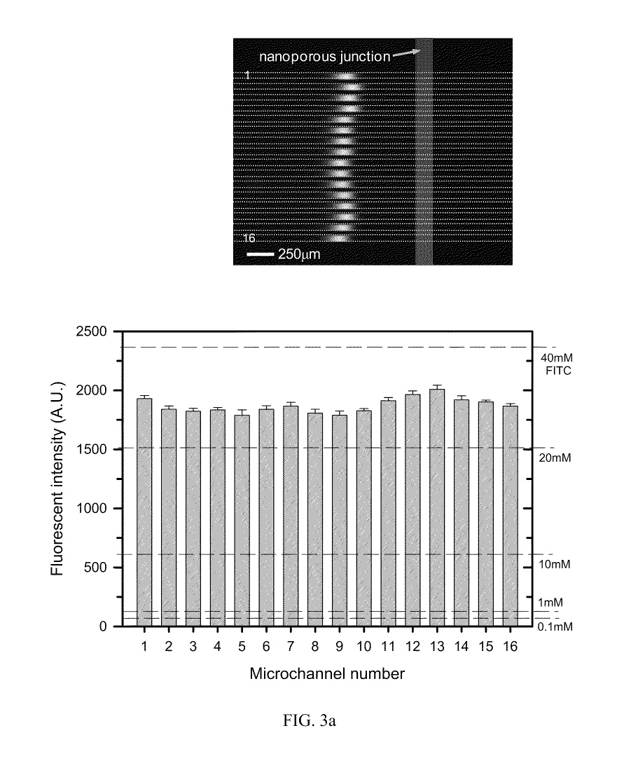

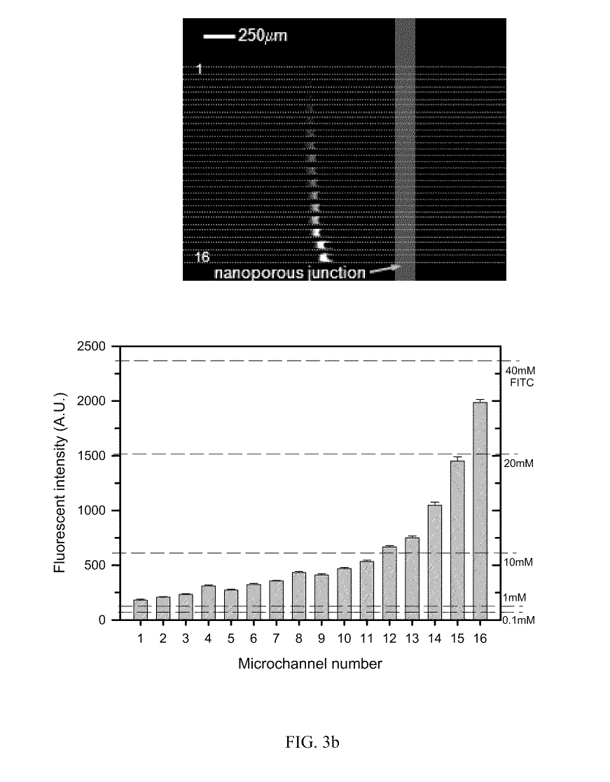

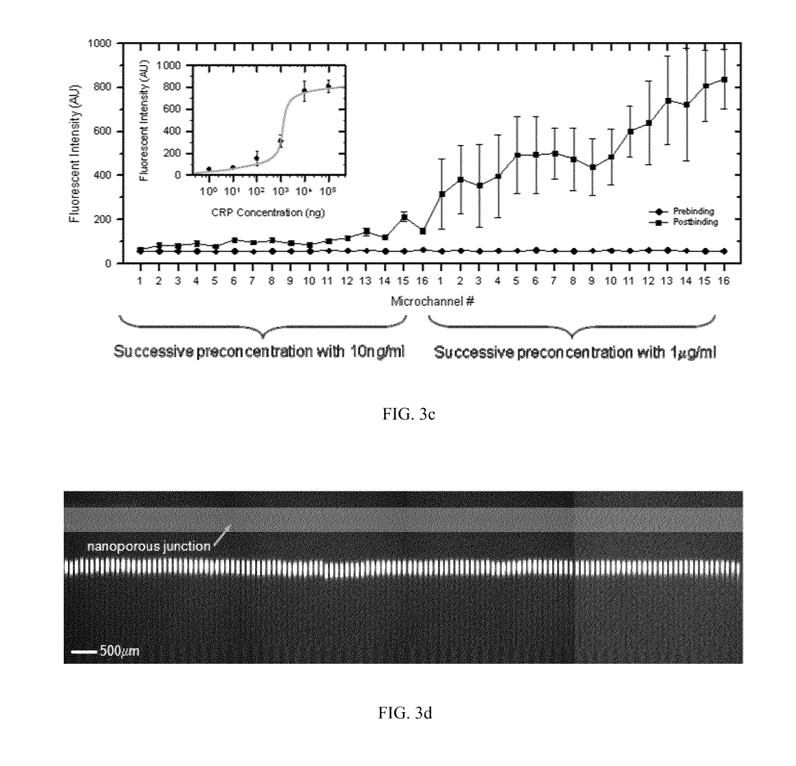

FIG. 3(a) shows that the 16-channel multiplexed preconcentration operation at the same concentration speed with only two electrical connections. Concentrated samples at each microchannel have the same fluorescent intensity, achieving the same preconcentrated factor. Initial concentration of fluorescent tracer (FITC) was 1 μM and almost 4,000 times of preconcentration factor was achieved with 30 minute concentration operation which is comparable or superior to previous concentration device. (Kim, S J. and J. Han, Self-Sealed Vertical Polymeric Nanoporous Junctions for High Throughput Nanofluidic Applications, Analytical Chemistry, 2008. 80 (9): p. 3507-3511; Wang, Y.-c. and J. Han, Pre-binding dynamic range and sensitivity enhancement for immuno-sensors using nanofluidic preconcentrator, Lab on a Chip, 2008. 8: p. 392-394.) The multiplexing allows for successive concentration with only two electrical connections. FIG. 3(b) shows the operation of the 16-channel multiplexed preconcentration device shown in FIG. 2(d) and the successive fluorescent intensities at each sample microchannel. In terms of preconcentration factor, 1,000-4,000 fold enhancements can be achieved by only one operation. Utilizing the gradient of concentration factor, one can carry out successive biding assay with larger dynamic range of detection.

Bead-based immuno-binding enhancement experiment was carried out based on published methodology. (Wang et. al., supra.) The experiments were done with 16-channel multiplexed concentration device. First, 1% BSA was coated (10 minutes) for preventing non-specific binding inside microchannels and the microchannels was washed with buffer solution several times. Then funtionalized-bead which has Streptavidin-anti-C-reactive protein (CRP) was loaded and the microchannels were washed again. Finally, Alexa-488 labeled CRP was concentrated at 100V for 30 minutes and the beads were washed with the same buffer solution several times. FIG. 3(c) shows the fluorescent intensity which shows the binding events according to the microchannel number. The plot was obtained two sets of experiment at 10 μg/ml and 1 μg/ml CRP concentration. As shown in the inset of FIG. 3(c), the binding between anti-CRP beads and CRP saturates over the CRP concentration range over 10 μg/ml. Serial binding event was observed, but the binding signal could not follow the signal of concentrated CRP which is at least 1,000 times greater than initial concentration. The reason is that the binding events strictly limited by the number of binding sites created from steptavidin-anti-CRP conjugate.

In addition to this, it is straightforward to fabricate more than 16-channel system. A 128-channel multiplexing concentration device was fabricated (same length) and its operation is shown in FIG. 3(d).

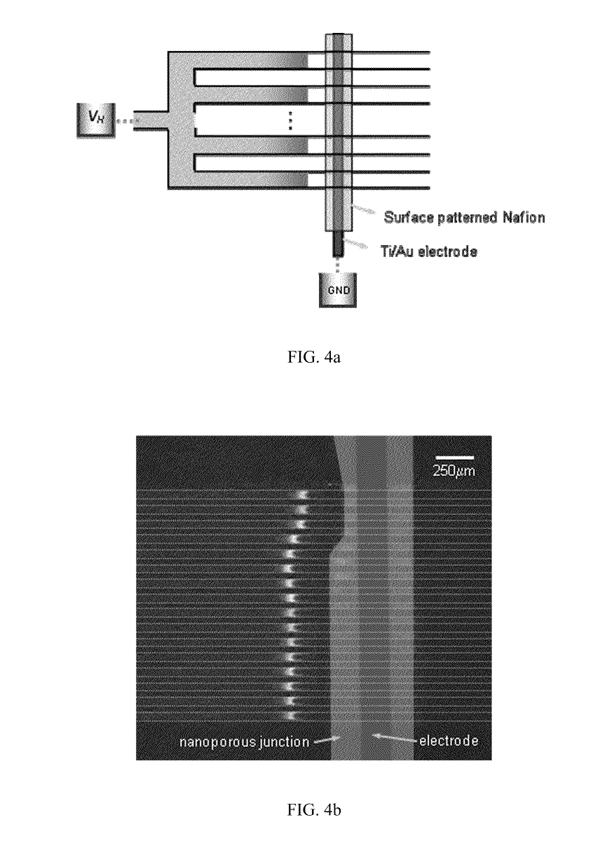

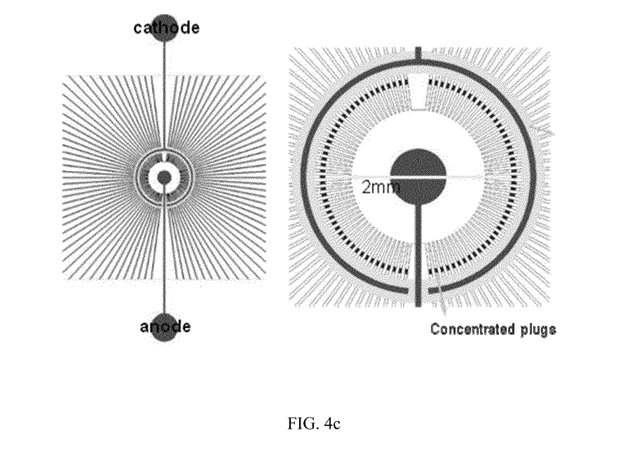

FIG. 4 depicts a device consisting of a number of microchannels which have one inlet and each outlet is open to external environment. In the middle of the microchannels, gold microelectrode with titanium as an adhesion layer (200 μm wide and 110 nm height) for solid buffer channel was deposited on a glass substrate using standard evaporation/lift-off process (Ti: 10 nm and Au: 100 nm) for solid buffer channel. Then, Nation was patterned using surface patterned method at 400 μm width. (Lee, J. H., Y.-A. Song, and J. Han, Multiplexed Proteomic Sample Preconcentration Device Using Surface-Patterned Ion-Selective Membrane Lab on a Chip, 2008. 8: p. 596-601). FIG. 4(b) shows the 16-channel multiplexing preconcentration using the device at the external voltage of 20V shown in FIG. 4(a). It also has only two electrical connections for the operation.

In systems without buffer channels, the design flexibility can be maximized. For example, the radial concentrating device shown in FIG. 4(c) has 100 concentrated plugs around the center hole. In such way, one can extract large amount of highly concentrated sample easily by conventional pipetting. Then, one can do a conventional bioanalysis outside the microchip while keeping micro/nanofluidic benefits (highly concentrated sample).

While this invention has been particularly shown and described with references to preferred embodiments thereof, it will be understood by those skilled in the art that various changes in form and details may be made therein without departing from the scope of the invention encompassed by the appended claims.

1. A microfluidic device comprising:
a first microchannel optionally connected to a first electrode;
a second set of two or more microchannels;
a nanoporous junction;
wherein said first microchannel is connected to said second set of microchannels;
and, wherein said nanoporous junction intersects at least part of said second set of microchannels.

2. The microfluidic device of claim 1 further comprising a third microchannel optionally connected to a second electrode wherein said third microchannel is connected to said second set of microchannels.

3. The microfluidic device according to claim 1, wherein said second set of microchannels contain a nanoporous junction.

4. The microfluidic device according to claim 3, wherein said junction is a nanochannel.

5. The microfluidic device according to claim 4, wherein said nanochannel is selected from between about 10-200 nm, between about 15-100 nm, between about 25-75 nm or between about 30-75 nm.

6. The microfluidic device according to claim 3, wherein said junction is a nanoporous polymeric junction.

7. The microfluidic device according to claim 3, wherein said junction contains a silicone based polymer.

8. The microfluidic device according to claim 3, wherein said junction contains polydimethylsiloxane.

9. The microfluidic device according to claim 1, wherein said first microchannel, or said second set of microchannels or said third microchannel have a depth of between about 0.5-200 μm or between about 5-150 μm or between about 5-100 μm or between about 5-50 μm or between about 5-25 μm or between about 10-25 μm or between about 10-20 μm.

10. The microfluidic device according to claim 1 wherein said first microchannel connected to a first electrode has a depth larger than said second set of microchannels.

11. The microfluidic device according to claim 1 wherein said first microchannel connected to a first electrode, or said second set of microchannels or said third microchannel have a width of between about 0.1-500 μm or between about 5-200 μm, or between about 10-100 μm, or between about 10-50 μm.

12. The microfluidic device according to claim 1 wherein said first microchannel connected to a first electrode has a width larger than said second set of microchannels.

13. A concentrating device comprising: a microfluidic device comprising a first channel or array of channels; a second planar array of channels connected to said first channel or planar array of channels through which a liquid comprising a species of interest can be made to pass; at least one rigid substrate connected thereto such that at least a portion of a surface of said substrate bounds said channels; an ion-selective membrane attached to at least a portion of said surface of said substrate, which bounds said channels; or an ion-selective membrane which bounds a portion of a surface of one of said channels; a unit to induce an electric field in said first channel; and a unit to induce an electrokinetic or pressure driven flow in said first channel or array of channels.

14. The device according to claim 13, wherein said species of interest comprises proteins, peptides, carbohydrates, polypeptides, nucleic acids, viral particles, or combinations thereof.

15. The device according to claim 13 wherein said second set of microchannels has 16 electrode-free microchannels.

16. The device according to claim 13 wherein said second set of microchannels has 64 electrode-free microchannels.

17. The device according to claim 13 wherein said second set of microchannels has 128 electrode-free microchannels.

18. The device according to claim 13 wherein the total number of electrodes connected to microchannels is fewer than the total number of microchannels.

19. The device according to claim 13 wherein the total number of electrodes connected to microchannels is less than 75% of the total number of microchannels.

20. The device according to claim 13 wherein the total number of electrodes connected to microchannels is less than 50% of the total number of microchannels.

21. The device according to claim 13 wherein the total number of electrodes connected to microchannels is less than 20% of the total number of microchannels.

22. The device according to claim 13 wherein the total number of electrodes connected to microchannels is less than 10% of the total number of microchannels.

23. The device according to claim 13 wherein the total number of electrodes connected to microchannels is less than 5% of the total number of microchannels.

24. The device according to claim 13 wherein said third channel is a buffer channel.

25. The device according to claim 24, wherein said buffer channel is connected to said second set of microchannels.

26. A microfluidic device comprising: a solid substrate; a single microfluidic channel or an array of microfluidic channels or a set of two or more microfluidic channels; a nanoporous junction intersecting a portion of said microfluidic channels; and a second solid substrate positioned so as to capture at least a portion of ions passing through said nanoporous junction.

27. A microfluidic device comprising:
a first microchannel optionally connected to a first electrode;
a second set of two or more sample microchannels;
a nanoporous junction;
wherein said first microchannel is connected to said second set of microchannels;
and, wherein said nanoporous junction intersects at least part of said second set of microchannels;
wherein said second set of microchannels contain at least two sample microchannels with different lengths wherein at least one sample microchannel is at least about 25%, 50%, 75%, 100%, 150%, 200%, 300%, 400%, 500%, 600%, 700%, 800%, 900%, 1,000%, 2,000%, 3,000%, 4,000%, 5,000%, 6,000%, 7,000%, 8,000%, 9,000%, 10,000%, 20,000%, 40,000%, 60,000%, 80,000%, 100,000% or 1,00,000% longer than the shortest sample microchannel.

28. The device of claim 28, wherein said second set of sample microchannels comprise between about 2 and 600,000 sample microchannels.

29. The device of claim 28, wherein said second set of sample microchannels comprise between about 2 and 66,000 sample microchannels or between about 2 and 33,000 sample microchannels or between about 2 and 17,000 sample microchannels, or between about 2 and 8200 sample microchannels or between about 2 and 4100 sample microchannels or between about 2 and 2050 sample microchannels or between about 2 and 1024 sample microchannels or between about 2 and 512 sample microchannels or between about 2 and 256 sample microchannels or between about 2 and 128 sample microchannels, or between about 2 and 64 sample microchannels, or between about 2 and 32 sample microchannels, or between about 2 and 16 sample microchannels, or between about 2 and 8 sample microchannels.

30. The device of claim 27 comprising 4, 8, 16, 32, 64, 128 or 256 sample microchannels.

31. The device of claim 30, wherein at least 1-255 sample microchannels are at least about 10%, 25%, 50%, 75%, 100%, 150%, 200%, 300%, 400%, 500%, 600%, 700%, 800%, 900%, 1,000%, 2,000%, 3,000%, 4,000%, 5,000%, 6,000%, 7,000%, 8,000%, 9,000%, 10,000%, 20,000%, 40,000%, 60,000%, 80,000%, 100,000% or 1,00,000% longer than the shortest sample microchannel.

32. The device of claim 27 wherein said shortest sample microchannel is between about 20-100,000 μm in length.

33. A method of processing a sample comprising the step of placing said sample in a device according to claim 1 and applying electric field.

34. The method according to claim 33, wherein said sample is placed in said first microchannel.

35. The method according to claim 33, wherein said sample contains a biopolymer.

36. The method according to claim 33, wherein said sample contains proteins, peptides, carbohydrates, polypeptides, nucleic acids, viral particles, or combinations thereof.
